(19) United States
(12) Patent Application Publication
(10) Pub. No.: US 2014/0269253 A1
(43) Pub. Date: Sep. 18, 2014

(54) METHOD AND DEVICE FOR ENTERING A NETWORK FOLLOWING AN ABNORMAL POWER DOWN IN A WIRELESS COMMUNICATION SYSTEM

(71) Applicant: LG ELECTRONICS INC., Seoul (KR)

(72) Inventors: Hee Jeong Cho, Anyang-si (KR); Young Soo Yuk, Anyang-si (KR)

(73) Assignee: LG ELECTRONICS INC., Seoul (KR)

(21) Appl. No.: 14/350,545

(22) PCT Filed: Oct. 9, 2012
(86) PCT No.: PCT/KR2012/008140

§ 371 Date: Apr. 8, 2014

Related U.S. Application Data
(60) Provisional application No. 61/546,563, filed on Oct. 13, 2011.
(60) Provisional application No. 61/545,200, filed on Oct. 10, 2011.

(51) Int. Cl. H04W 4/00; H04W 8/24; H04W 24/04

(52) U.S. Cl. CPC H04W 4/005; H04W 24/04; H04W 8/24
USPC 370/217

(57) ABSTRACT

The present invention relates to a method and device for maintaining the context of user equipment (UE) in a wireless communication system. If power for a terminal is abnormally down, a base station receives an abnormal power down report and a request for maintaining the context of the terminal from the terminal, determines whether to maintain the context of the terminal, and transmits, to the terminal, an abnormal power down confirmation that indicates whether to maintain the context of the terminal.

### BACKGROUND OF THE INVENTION

1. Field of the Invention

The present invention relates to wireless communications, and more particularly, to a method and apparatus for entering a network according to an abnormal power down in a wireless communication system.

2. Related Art

The institute of electrical and electronics engineers (IEEE) 802.16e standard was adopted in 2007 as a sixth standard for international mobile telecommunication (IMT)-2000 in the name of ‘WMAN-OFDMA TDD’ by the ITU-radio communication sector (ITU-R) which is one of sectors of the international telecommunication union (ITU). An IMT-advanced system has been prepared by the ITU-R as a next generation (i.e., 4th generation) mobile communication standard following the IMT-2000. It was determined by the IEEE 802.16 working group (WG) to conduct the 802.16m project for the purpose of creating an amendment standard of the existing IEEE 802.16e as a standard for the IMT-advanced system. As can be seen in the purpose above, the 802.16m standard has two aspects, that is, continuity from the past (i.e., the amendment of the existing 802.16e standard) and continuity to the future (i.e., the standard for the next generation IMT-advanced system). Therefore, the 802.16m standard needs to satisfy all requirements for the IMT-advanced system while maintaining compatibility with a mobile WiMAX system conforming to the 802.16e standard.

There is ongoing development on the IEEE 802.16p standard optimized for machine-to-machine (M2M) communication based on the IEEE 802.16e standard and the IEEE 802.16m standard. The M2M communication can be defined as an information exchange performed between a subscriber station and a server or between subscriber stations in a core network without any human interaction. In the IEEE 802.16p standard, there is an ongoing discussion on enhancement of medium access control (MAC) of the IEEE 802.16 standard and a minimum change of an orthogonal frequency division multiple access (OFDMA) physical layer (PHY) in licensed bands. Due to the discussion on the IEEE 802.16p standard, a wide area wireless coverage is required in the licensed band, and a scope of applying automated M2M communication can be increased for an observation and control purpose.

When accessing a network, requirements demanded by many M2M applications are significantly different from requirements for human-initiated or human-controlled network access. The M2M application can include vehicular telematics, healthcare monitoring of bio-sensors, remote maintenance and control, smart metering, an automated service of a consumer device, etc. The requirements of the M2M application can include very lower power consumption, larger numbers of devices, short burst transmission, device tampering detection and reporting, improved device authentication, etc.

A user equipment or an M2M device may be abnormally powered down. The user equipment or M2M device which is abnormally powered down needs to perform an initial network entry process when attempting network entry again. That is, the corresponding use equipment or M2M device needs to perform all procedures required for the network entry. Accordingly, a new network reentry method is required, which can reduce overhead by minimizing and/or skipping the procedures required for network reentry of the corresponding user equipment or M2M device.

### SUMMARY OF THE INVENTION

The present invention provides a method and apparatus for entering a network according to an abnormal power down in a wireless communication system. The present invention provides a method for requesting, by a user equipment, from a base station to retain information on the user equipment when power of the user equipment is abnormally down. Further, the present invention provides a method for allocating, by a base station, an identifier for network reentry to a user equipment.

In an aspect, a method for retaining, by a base station, a context of a user equipment (UE) in a wireless communication system is provided. The method includes receiving an abnormal power down report and a request for retaining a context of a UE from the UE when an abnormal power down of the UE occurs, determining whether to retain the context of the UE, and transmitting an abnormal power down confirmation that indicates whether to retain the context of the UE to the UE.

In another aspect, a method for performing, by user equipment (UE), network reentry in a wireless communication system is provided. The method includes transmitting an abnormal power down report and a request for retaining a context of a UE to a base station (BS) when an abnormal power down of the UE occurs, receiving an abnormal power down confirmation, which indicates whether the context of the UE is retained, and an identifier of the UE from the BS, and performing network reentry with the BS by transmitting the identifier of the UE to the BS.

In another aspect, a user equipment (UE) performing network reentry in a wireless communication system is provided. The UE includes a radio frequency (RF) unit for transmitting or receiving a radio signal, and a processor coupled to the RF unit, and configured to transmit an abnormal power down report and a request for retaining a context of a UE to a base station (BS) when an abnormal power down of the UE occurs, receive an abnormal power down confirmation, which indicates whether the context of the UE is retained, and an identifier of the UE from the BS, and perform network reentry with the BS by transmitting the identifier of the UE to the BS.

A user equipment which is abnormally powered down can rapidly perform network reentry.

### BRIEF DESCRIPTION OF THE DRAWINGS

FIG. 1 shows a wireless communication system.

FIG. 2 shows basic M2M service system architecture of IEEE 802.16 supporting machine-to-machine (M2M) communication.

FIG. 3 shows advanced M2M service system architecture of IEEE 802.16 supporting M2M communication.

FIG. 4 shows an example of an IEEE 802.16m frame structure.

FIG. 5 shows an example of structure of a BR tile.

FIG. 6 shows an example of a 3-step BR process.

FIG. 7 shows an example of a 5-step BR process.

FIG. 8 shows an example of a process of reporting an abnormal power down.

FIG. 9 shows an example of a method for retaining context of a UE under an abnormal power down according to an embodiment of the present invention.

FIG. 10 is a block diagram showing wireless communication system to implement an embodiment of the present invention.

### DESCRIPTION OF EXEMPLARY EMBODIMENTS

A technology below can be used in a variety of wireless communication systems, such as code division multiple access (CDMA), frequency division multiple access (FDMA), time division multiple access (TDMA), orthogonal frequency division multiple access (OFDMA), and single carrier frequency division multiple access (SC-FDMA). CDMA can be implemented using radio technology, such as universal terrestrial radio access (UTRA) or CDMA2000. TDMA can be implemented using radio technology, such as global system for mobile communications (GSM)/general packet radio service (GPRS)/enhanced data rates for GSM evolution (EDGE). OFDMA can be implemented using radio technology, such as IEEE 802.11 (Wi-Fi), IEEE 802.16 (WiMAX), IEEE 802-20, or Evolved UTRA (E-UTRA). IEEE 802.16m is the evolution of IEEE 802.16e, and it provides a backward compatibility with an IEEE 802.16e-based system. UTRA is part of a universal mobile telecommunications system (UMTS). 3rd generation partnership project (3GPP) long term evolution (LTE) is part of evolved UMTS (E-UMTS) using evolved-UMTS terrestrial radio access (E-UTRA), and it adopts OFDMA in downlink (DL) and SC-FDMA in uplink (UL). LTE-A (advanced) is the evolution of 3GPP LTE.

IEEE 802.16m is chiefly described as an example in order to clarify the description, but the technical spirit of the present invention is not limited to IEEE 802.16m.

FIG. 1 shows a wireless communication system.

Referring to FIG. 1, the wireless communication system 10 includes one or more base stations (BSs) 11. The BSs 11 provide communication services to respective geographical areas (in general called ‘cells’) 15a, 15b, and 15c. Each of the cells can be divided into a number of areas (called ‘sectors’). A user equipment (UE) 12 can be fixed or mobile and may be referred to as another terminology, such as a mobile station (MS), a mobile terminal (MT), a user terminal (UT), a subscriber station (SS), a wireless device, a personal digital assistant (PDA), a wireless modem, or a handheld device. In general, the BS 11 refers to a fixed station that communicates with the UEs 12, and it may be referred to as another terminology, such as an evolved-NodeB (eNB), a base transceiver system (BTS), or an access point.

The UE generally belongs to one cell. A cell to which a UE belongs is called a serving cell. A BS providing the serving cell with communication services is called a serving BS. A wireless communication system is a cellular system, and so it includes other cells neighboring a serving cell. Other cells neighboring the serving cell are called neighbor cells. A BS providing the neighbor cells with communication services is called as a neighbor BS. The serving cell and the neighbor cells are relatively determined on the basis of a UE.

This technology can be used in the downlink (DL) or the uplink (UL). In general, DL refers to communication from the BS 11 to the UE 12, and UL refers to communication from the UE 12 to the BS 11. In the DL, a transmitter may be part of the BS 11 and a receiver may be part of the UE 12. In the UL, a transmitter may be part of the UE 12 and a receiver may be part of the BS 11.

FIG. 2 shows basic M2M service system architecture of IEEE 802.16 supporting machine-to-machine (M2M) communication.

A basic M2M service system architecture 20 includes a mobile network operator (MNO) 21, a M2M service consumer 24, at least one IEEE 802.16 M2M device (hereinafter, 802.16 M2M device) 28, and at least one non-IEEE 802.16 M2M device 29. The MNO 21 includes an access service network (ASN) and a connectivity service network (CSN). The 802.16 M2M device 28 is an IEEE 802.16 mobile station (MS) having a M2M functionality. A M2M server 23 is an entity for communicating with one or more 802.16 M2M devices 28. The M2M server 23 has an interface accessibly by the M2M service consumer 24. The M2M service consumer 24 is a user of a M2M service. The M2M server 23 may be located inside or outside the CSN, and can provide a specific M2M service to the one or more 802.16 M2M devices 28. The ASN may include an IEEE 802.16 base station (BS) 22. A M2M application operates based on the 802.16 M2M device 28 and the M2M server 23.

The basic M2M service system architecture 20 supports two types of M2M communication, i.e., M2M communication between one or more 802.16 M2M devices and a M2M server or point-to-multipoint communication between the 802.16 M2M devices and an IEEE 802.16 BS. The basic M2M service system architecture of FIG. 2 allows the 802.16 M2M device to operate as an aggregation point for a non-IEEE 802.16 M2M device. The non-IEEE 802.16 M2M device uses a radio interface different from IEEE 802.16 such as IEEE 802.11, IEEE 802.15, PLC, or the like. In this case, the non-IEEE 802.16 M2M device is not allowed to change the radio interface to IEEE 802.16.

FIG. 3 shows advanced M2M service system architecture of IEEE 802.16 supporting M2M communication.

In the advanced M2M service system architecture, an 802.16 M2M device can operate as an aggregation point for a non-IEEE 802.16 M2M device, and also can operate as an aggregation point for an 802.16 M2M device. In this case, in order to perform an aggregation function for the 802.16 M2M device and the non-802.16 M2M device, the radio interface can be changed to IEEE 802.16. In addition, the advanced M2M service system architecture can support a peer-to-peer (P2P) connection between 802.16 M2M devices. In this case, the P2P connection can be established on either IEEE 802.16 or another radio interface such as IEEE 802.11, IEEE 802.15, PLC, or the like.

FIG. 4 shows an example of an IEEE 802.16m frame structure.

Referring to FIG. 4, a superframe (SF) includes a superframe header (SFH) and four frames F0, F1, F2, and F3. Each frame may have the same length in the SF. Although it is shown that each SF has a size of 20 milliseconds (ms) and each frame has a size of 5 ms, the present invention is not limited thereto. A length of the SF, the number of frames included in the SF, the number of SFs included in the frame, or the like may change variously. The number of SFs included in the frame may change variously according to a channel bandwidth and a cyclic prefix (CP) length.

One frame includes 8 subframes SF0, SF1, SF2, SF3, SF4, SF5, SF6, and SF7. Each subframe can be used for UL or DL transmission. One subframe includes a plurality of orthogonal frequency division multiplexing (OFDM) symbols or orthogonal frequency division multiple access (OFDMA) symbols in a time domain, and includes a plurality of subcarriers in a frequency domain. An OFDM symbol is for representing one symbol period, and can be referred to as other terminologies such as an OFDMA symbol, an SC-FDMA symbol, etc., according to a multiple access scheme. The subframe can consist of 5, 6, 7, or 9 OFDMA symbols. However, this is for exemplary purposes only, and thus the number of OFDMA symbols included in the subframe is not limited thereto. The number of OFDMA symbols included in the subframe may change variously according to a channel bandwidth and a CP length. A subframe type may be defined according to the number of OFDMA symbols included in the subframe. For example, it can be defined such that a type-1 subframe includes 6 OFDMA symbols, a type-2 subframe includes 7 OFDMA symbols, a type-3 subframe includes 5 OFDMA symbols, and a type-4 subframe includes 9 OFDMA symbols. One frame may include subframes each having the same type. Alternatively, one frame may include subframes each having a different type. That is, the number of OFDMA symbols included in each subframe may be identical or different in one frame. Alternatively, the number of OFDMA symbols included in at least one subframe of one frame may be different from the number of OFDMA symbols of the remaining subframes of the frame.

Time division duplex (TDD) or frequency division duplex (FDD) can be applied to the frame. In the TDD, each subframe is used in UL or DL transmission at the same frequency and at a different time. That is, subframes included in a TDD frame are divided into a UL subframe and a DL subframe in the time domain. In the FDD, each subframe is used in UL or DL transmission at the same time and at a different frequency. That is, subframes included in an FDD frame are divided into a UL subframe and a DL subframe in the frequency domain. UL transmission and DL transmission occupy different frequency bands and can be simultaneously performed.

A superframe header (SFH) can carry an essential system parameter and system configuration information. The SFH may be located in a first subframe in a superframe. The SFH may occupy last 5 OFDMA symbols of the first subframe. The SFH can be classified into a primary-SFH (P-SFH) and a secondary-SFH (S-SFH). The P-SFH may be transmitted in every superframe. Information transmitted on the S-SFH can be divided into 3 sub-packets, i.e., S-SFH SP1, S-SFH SP2, and S-SFH SP3. Each sub-packet can be transmitted periodically with a different periodicity. Information transmitted through the S-SFH SP1, the S-SFH SP2, and the S-SFH SP3 may be different from one another. The S-SFH SP1 may be transmitted with the shortest period, and the S-SFH SP3 may be transmitted with the longest period. The S-SFH SP1 includes information on network re-entry, and a transmission period of the S-SFH SP1 may be 40 ms. The S-SFH SP2 includes information on initial network entry and network discovery, and a transmission period of the S-SFH SP2 may be 80 ms. The S-SFH SP3 includes other important system information, and a transmission period of the S-SFH SP3 may be either 160 ms or 320 ms.

One OFDMA symbol includes a plurality of subcarriers, and the number of subcarriers is determined according to a fast Fourier transform (FFT) size. There are several types of subcarriers. A subcarrier type may include a data subcarrier for data transmission, a pilot subcarrier for various estimations, and a null carrier for a guard band and a DC carrier. A parameter for characterizing an OFDMA symbol includes BW, N_{used}, n, G, etc. BW denotes a nominal channel bandwidth. N_{used} denotes the number of subcarriers in use (including a DC subcarrier). n denotes a sampling factor. This parameter is used to determine a subcarrier spacing and a useful symbol time together with BW and N_{used}. G denotes a ratio of a CP time and a useful time.

Table 1 below shows an OFDMA parameter. The OFDMA parameter of Table 1 can equally apply to the 802.16e frame structure of FIG. 4.

TABLE 1

| Channel bandwidth, BW(MHz) | | | 5 | 7 | 8.75 | 10 | 20 |
|---|---|---|---|---|---|---|---|
| Sampling factor, n | | | 28/25 | 8/7 | 8/7 | 28/25 | 28/25 |
| Sampling frequency, Fₛ(MHz) | | | 5.6 | 8 | 10 | 11.2 | 22.4 |
| FFT size, N_{FFT} | | | 512 | 1024 | 1024 | 1024 | 2048 |
| Subcarrier spacing, Δf(kHz) | | | 10.94 | 7.81 | 9.77 | 10.94 | 10.94 |
| Useful symbol time, T_{b}(μs) | | | 91.4 | 128 | 102.4 | 91.4 | 91.4 |
| G = ⅛ | Symbol time, Tₛ(μs) | | 102.857 | 144 | 115.2 | 102.857 | 102.857 |
| | FDD | Number of | 48 | 34 | 43 | 48 | 48 |
| | | ODFMA symbols | | | | | |
| | | per 5 ms frame | | | | | |
| | | Idle time(μs) | 62.857 | 104 | 46.40 | 62.857 | 62.857 |
| | TDD | Number of | 47 | 33 | 42 | 47 | 47 |
| | | ODFMA symbols | | | | | |
| | | per 5 ms frame | | | | | |
| | | TTG + RTG(μs) | 165.714 | 248 | 161.6 | 165.714 | 165.714 |
| G = 1/16 | Symbol time, Tₛ(μs) | | 97.143 | 136 | 108.8 | 97.143 | 97.143 |
| | FDD | Number of | 51 | 36 | 45 | 51 | 51 |
| | | ODFMA symbols | | | | | |
| | | per 5 ms frame | | | | | |
| | | Idle time(μs) | 45.71 | 104 | 104 | 45.71 | 45.71 |
| | TDD | Number of | 50 | 35 | 44 | 50 | 50 |
| | | ODFMA symbols | | | | | |
| | | per 5 ms frame | | | | | |
| | | TTG + RTG(μs) | 142.853 | 240 | 212.8 | 142.853 | 142.853 |
| G = ¼ | Symbol time, Tₛ(μs) | | 114.286 | 160 | 128 | 114.286 | 114.286 |
| | FDD | Number of | 43 | 31 | 39 | 43 | 43 |
| | | ODFMA symbols | | | | | |
| | | per 5 ms frame | | | | | |
| | | Idle time(μs) | 85.694 | 40 | 8 | 85.694 | 85.694 |
| | TDD | Number of | 42 | 30 | 38 | 42 | 42 |
| | | ODFMA symbols | | | | | |
| | | per 5 ms frame | | | | | |
| | | TTG + RTG(μs) | 199.98 | 200 | 136 | 199.98 | 199.98 |

| | | | | | | |
|---|---|---|---|---|---|---|
| Number of Guard | Left | 40 | 80 | 80 | 80 | 160 |
| subcarriers | Right | 39 | 79 | 79 | 79 | 159 |

| | | | | | |
|---|---|---|---|---|---|
| Number of used subcarriers | 433 | 865 | 865 | 865 | 1729 |
| Number of PRU in type-1 subframe | 24 | 48 | 48 | 48 | 96 |

In Table 1, N_{FFT} is smallest power of two greater than N_{used}. A sampling factor Fₛ is floor(n·BW/8000)×8000, a subcarrier spacing Δf is Fₛ/N_{FFT}, a useful symbol time T_{b} is 1/Δ, a CP time T_{g} is G·T_{b}, an OFDMA symbol time Tₛ is T_{b}+T_{g}, and a sampling time is T_{b}/N_{FFT}.

Hereinafter, a bandwidth request channel (BRCH) is described.

The BRCH is a channel to request radio resources for transmitting uplink data or a control signal to be transmitted by a UE. Bandwidth request information may be transmitted on the BRCH by using contention based random access. The BRCH includes resources for the UE to transmit a BR preamble and an additional quick access message. The BRCH may be configured by a BR tile.

FIG. 5 shows an example of structure of a BR tile.

Referring to FIG. 5, the BR tile may be defined by 6 consecutive subcarriers and 6 OFDMA symbols. Each BRCH includes 3 distributed BR tiles for frequency diversity. The BR tile is constituted by a preamble part Pr and a data part M. The preamble part may transmit the BR preamble on resources constituted by 6 OFDMA symbols and 4 subcarriers. The data part may transmit a quick access message on resources constituted by 6 OFDMA symbols and 2 consecutive subcarriers. In the BRCH, each BR tile may carry a part of the same preamble quick access message. The UE may transmit only the BR preamble and may remain the resources for the quick access message. The UE may determine whether to transmit only the BR preamble or both the BR preamble and the quick access message.

The UE may perform a contention based BR by using the BR preamble and the additional quick access message transmitted on the BRCH or a standalone BR transmitted through a BR signaling header, etc. Each BRCH may indicate one BR opportunity. The BR may be generally performed through a process of three steps or five steps. The 3-step BR process is used for performing a more rapid BR and the 5-step BR process is used for more stably performing the contention based BR process. The BS or the UE may determine which BR process the BR is to be performed through.

FIG. 6 shows an example of a 3-step BR process.

In step S50, the UE transmits a BR preamble sequence and a quick access message to the BS on a randomly selected BRCH. The quick access message carries 12-bit information including address information of the UE and additional 4-bit BR information. Table 2 shows an example of a quick access message format.

TABLE 2

| | | |
|---|---|---|
| | Size | |
| Field | (bits) | Notes |

Quick Access Message( ){

| | | |
|---|---|---|
| STID | 12 | Station ID |
| Predefined BR index | 4 | Range: 0-15. Definition is MS |

| | |
|---|---|
| | specific based on AAI-DSx |
| | negotiation |
| } | |

In step S51, the BS transmits a grant for UL transmission to the UE. In this case, the BS may transmit acknowledgement (ACK) that means the BS receives the BR preamble sequence or the quick access message together. In transmitting the ACK, if the BS detects at least one BR preamble sequence in the BR opportunities of frame n, and the BS does not grant UL resources by the CDMA_Allocation_IE, the UL subband assignment A-MAP IE, or the UL basic assignment IE to all the successfully received BR requests before or in the frame n+BR_ACK_Offset, at least one BR-ACK A-MAP IE shall be sent at the DL frame of the frame n+BR_ACK_Offset. Further, the ABS may send multiple BR-ACK A-MAP IEs in the subframes in the DL frame of frame n+BR_ACK_Offset, with each BR-ACKA-MAP IE containing its own bitmap relating to the preamble sequences being acknowledged/granted in this A-MAP IE alone. Each UE should try to decode all BR-ACK MAP-IEs at the DL frame offrame n+BR_ACK_Offset after it transmitted a BR preamble sequence. In this case if no BR-ACK A-MAP IEs are sent at the DL frame of frame n+BR_ACK_Offset and the UE does not receive any UL grant before or in frame n+BR_ACK_Offset, the UE considers it as an implicit negative ACK (NACK) and may restart BR process.

Table 3 shows an example of the BR-ACK A-MAP IE.

TABLE 3

| | | |
|---|---|---|
| | Size | |
| Field | (bits) | Notes |

BR-ACK_A-MAP_IE( ){

| A-MAP IE Type | 4 | BR-ACK A-MAP IE |
|---|---|---|
| BR-ACK Bitmap | N_BR_Opportunities | Each bit indicates whether this BR-ACK A-MAP |
| | | IE includes the decoding status of the BR |
| | | preamble in the corresponding BR opportunity or |
| | | not. The bitmap size is the number of BR |
| | | opportunities in a frame, and the bitmap is |
| | | encoded in ascending order of the BR opportunity |
| | | index. |
| | | 0b0: No BR preamble sequence is detected, |
| | | 0b1: At least one preamble sequence is detected |
| | | N_BR_Opportunities ≦ 4 |
| MSB of resource start offset | 2 | 0b00, 0b01, 0b10: 2-bit-MSB of the start offset of |

the resource allocation (LRU)
0b11: No grant exist in this BR ACK A-MAP IE.

If(MSB of resource start

offset != 0b11){

| LSB of resource start offset | 5 | This field is the LSB of the start offset of the |
|---|---|---|
| | | Resource allocation (LRU) for BR Header |
| HFA start offset | 6 | This field is start offset of HARQ Feedback |
| | | Allocation. |
| Allocation size | 1 | Resource size for each BR header |
| | | 0b0: 1 LRU |
| | | 0b1: 2 LRUs |
| Long TTI Indicator | 1 | Indicates number of AAI subframes spanned by |

the allocated resource for BR header.
0b0: 1 AAI subframe (default)
0b1: 4 UL AAI subframes for FDD or all UL
subframes for TDD
If number of DL AAI subframes, D, is less than
number of UL AAI subframes, U, Long TTI
Indicator = 0b1

}

for(i=0;i<N_BR_Opportunities;i++){

If(BR-ACK Bitmap[i]==1){

| | | |
|---|---|---|
| Number of received | 2 | The number of BR preamble sequence indices |

| | |
|---|---|
| preamble sequences (L) | included in this ACK A-MAP IE. |

for(j=0;j<L;j++){

| Preamble sequence index | 5 | Preamble sequence index 5 Preamble sequence |
|---|---|---|
| | | index received in the BR opportunity |
| MSG decoding indicator | 1 | To indicate the decoding status of quick access |

message
0b0: MSG not decoded
0b1: MSG decoded relevant to Preamble
sequence index

if(MSB of resource start

offset!=0b11)&&(MSG
decoding indicator==0b0){

| | | |
|---|---|---|
| Grant indicator | 1 | To indicate whether grant of BR Header for the |

BR preamble sequence index is included or not
0b0: No UL resource allocation
0b1: UL resource allocation for BR with STID
header

}

}

}

| | | |
|---|---|---|
| } | | |
| reserved | variable | To reach 40-bit assignment A-MAP IE size. |

}

Referring to Table 3, the BR-ACK A-MAP IE indicates a decoding status of each BR opportunity in the n-th frame. Each BR-ACK A-MAP IE contains its own BR-ACK bitmap of size equal to the number of BR opportunities in the n-th frame. The BR preamble sequence indices in BR opportunities acknowledged in each BR-ACK A-MAP IE shall be mutual exclusive. Further, the BR-ACK A-MAP IE indicates correctly received BR preamble sequences in the BR opportunities of the n-th frame. Further, the BR-ACK A-MAP IE indicates a decoding status of the quick access message for each correctly received BR preamble sequence.

If the BR-ACK bitmap(s) indicates no BR preamble sequence is detected at the BR opportunity selected by the UE, or the UE's BR preamble sequence is not included at the selected BR opportunity in the BR ACK A-MAP IE(s), the UE shall consider that it has received a NACK. The UE shall wait until the last DL subframe of the frame where the BR-ACK A-MAP IE(s) is transmitted before deciding it has received an implicit NACK. The UE shall start a BR timer if the UE receives a BR-ACK A-MAP IE indicating a successful reception of the BR preamble sequence but the UE does not receive any UL grant before or in the frame that the BRACK A-MAP IE is received. If the BR-ACK A-MAP IE indicates successful reception of BR preamble sequence and quick access message, the BR timer value shall be set to the differentiated BR timer acquired during the DSx transaction. For all other cases, the BR Timer value shall be fixed. The UE shall stop the BR timer upon reception of the UL grant.

The UE considers the BR as failed and may restart the BR process when the UE receives a NACK or the BR timer expires.

Referring back to FIG. 6, in step S52, the UE performs scheduled UL transmission.

During the 3-step BR process, if the BS is unable to decode the quick access message, the BS falls back to the 5-step BR process. The 5-step BR process may be standalone performed or performed as an alternative BR process against a case in which the 3-step BR process of FIG. 6 fails.

FIG. 7 shows an example of a 5-step BR process.

In step S60, the UE transmits the BR preamble sequence to the BS. In this case, the quick access message may be additionally transmitted.

If the BS is unable to decode the quick access message, the BS shall provide an UL grant to the UE using a BR ACK A-MAP IE or CDMA allocation A-MAP IE in step S61. The UL grant may be a grant for a standalone BR header. The maximum HARQ retransmission of the allocation mode through the BR-ACK A-MAP IE or CDMA allocation A-MAP IE is set as to the default value.

In step S62, the UE transmits a standalone BR header only to the BS.

The UE shall start the BR timer after sending BR header to the BS. The BR timer value shall be set to the differentiated BR timer acquired during the DSx transaction. The UE shall stop the BR timer upon reception of the UL grant. The UE may restart the BR process if BR timer is expired.

In step S63, the BS transmits the grant for the UL transmission to the UE.

In step S64, the UE performs scheduled UL transmission.

Hereinafter, an abnormal power down is described.

When the UE detects the abnormal power down, the UE attempts to transmit a ranging request message (AAI-RNG-REQ) including a ranging purpose indication field that indicates that power is abnormally or unintentionally down. A value of the ranging purpose indication field may be 0b1110. In this case, the UE may be an M2M device.

When the UE is in a connected state and when a UL bandwidth has already been allocated and is available, the UE may transmit the AAI-RNG-REQ message including the ranging purpose indication field by using the available UL bandwidth. When the UE is in the connected state, but there no available UL bandwidth, the UE may request a bandwidth to transmit the AAI-RNG-REQ message. The UE may receive the BR to transmit the AAI-RNG-REQ message including the ranging purpose indication field by using the available UL bandwidth. When the UE is in the connected state, but there is no available UL bandwidth, the UE may report the abnormal power down by using a quick access process. A predetermined BR index may be used to indicate that the power is abnormally or unintentionally down.

FIG. 8 shows an example of a process of reporting an abnormal power down.

In step S70, the UE transmits the BR preamble sequence to the BS.

In step S71, the BS transmits the BR-ACK A-MAP IE to the UE. In step S72, the BS transmits the standalone BR header to the UE.

When the UE detects the abnormal power down, the UE transmits to the BS an abnormal power down signaling header that indicates that the power is abnormally or unintentionally down in step S73. Table 4 shows an example of the abnormal power down signaling header when the UE which is abnormally powered down is the M2M device.

TABLE 4

| | | |
|---|---|---|
| | Size | |
| Field | (bits) | Notes |

Emergency report ( ) {

| FID | 4 | Flow Identifier. Set to 0b0010 |
|---|---|---|
| Type | 5 | MAC Signaling header type = 0b01000 |
| Length | 3 | Indicates the length of the signaling header in bytes |
| STID | 12 | STID of the M2M device that transmits power down |
| | | report signaling header |
| STID_Valid_Offset | 3 | STID_Valid_Offset of the M2M device that sends |
| | | power down report. If the assigned STID is not |
| | | shared with other M2M devices, M2M device shall set |
| | | this field to zero. |
| Emergency Type | 3 | 0b000: Power Outage |

| | | 0b001~0b111: Reserved |
|---|---|---|
| Reserved | 18 | Reserved. This field shall be set to Zero. |

}

Referring to Table 4, the abnormal power down signaling header includes a STID-_Valid_Offset field and an Emergency Type field. A value of the Emergency Type field is set to 0 to indicate that the power is abnormally or unintentionally down.

The predetermined BR index used to indicate that the power is abnormally or unintentionally down may be defined by a dynamic service addition (DSA) request message (AAI-DSA-REQ). The AAI-DSA-REQ message may include a predetermined BR index parameter. The predetermined BR index parameter defines mapping of a BR action and a BR size used during the 3-step BR process from the predetermined BR index. The predetermined BR index parameter may be included only in the ABS-initiated AAI-DSA-REQ message. The predetermined BR index parameter may be determined based on quality of service (QoS) parameters of a service flow in an AAI-DSx message. When a value of the BR action field in the AAI-DSA-REQ message is 0b00 or 0b01, the same BR index is not allocated to different service flows. When the value of the BR action field in the AAI-DSA-REQ message is 0b10, the BS allocates different BR indices to service flows in which UL grant scheduling types are different each other and allocates different BR indices to different service flows in which the UL grant scheduling types are the same but the BR sizes are different each other. When the value of the BR action field in the AAI-DSA-REQ message is 0b11, a purpose indication field may be included to indicate an action of the M2M device. Table 5 shows an example of a part of the AAI-DSA-REQ message.

TABLE 5

| | Size | | |
|---|---|---|---|
| Field | (bits) | Value/Description | Conditions |
| For(i = 1; i≦ N- | | The mapping of predefined BR index | |
| Predefined-BR- | | used in quick access message to BR size | |
| indices; i++) { | | and BR actions N-Predefined-BR-indices | |
| | | is the number of predefined BR indices | |
| | | [1 . . . 15] | |
| Predefined BR | 4 | Predefined BR index | Present if N-Predefined- |
| index | | | BR-indices is not zero |
| BR action | 2 | 0b00: ertPS service flow requests to | Present if N-Predefined- |
| | | resume to maximum sustained rate | BR-indices is not zero |
| | | 0b01: aGP service flow requests to switch | |
| | | to Primary QoS parameters | |
| | | 0b10: BR | |
| | | 0b11: Abnormal Power Down Indication | |
| ... | | | |

Referring to Table 5, when the value of the BR action field in the AAI-DSA-REQ message is 0b11, the abnormal power down may be indicated.

Meanwhile, the STID may be used to identify the M2M device in a domain of the BS. The BS may allocate the same STID to a plurality of M2M devices. When the STID allocated to any one M2M device is shared by other M2M device, the BS may set a frame in which the STID allocated to the M2M device is valid. The STID allocated to the M2M device may be valid in only a frame that satisfies a specific condition (Framenum). The specific condition may be Framemum mod (STID Valid Periodicity)=STID Valid Offset. The Framenum represents a frame sequence number. An STID Valid Periodicity parameter and an STID Valid Offset parameter are transmitted from the BS through a registration response message (AAI-REG-RSP). For the M2M device that shares the same STID, the STID Valid Periodicity value is the same and the STID Valid Offset value is unique.

An STID sharing method may be proposed to increase a capacity of an ID for numerous M2M devices. The M2M device may transmit and receive data in a specific frame based on the allocated STID Valid Periodicity parameter and STID Valid Offset parameter. The STID sharing method does not interfere with the M2M device's performing the BR even in any frame. Accordingly, different predetermined BR indices transmitted by the quick access message may be used to identify the M2M devices that share the STID and to this end, the value of the BR action field of the AAI-DSA-REQ message may be set to 0b11.

When the UE which is abnormally powered down enters the network again, the corresponding UE needs to perform initial network entry. That is, the UE which is abnormally powered down needs to perform all required procedures. Meanwhile, the BS and a core network (for example, a mobile switching center) may have information and/or context of the UE that has already entered the network. The information of the UE may be a media access control (MAC) address, authentication associated information, etc. Accordingly, when the UE notifies the abnormal power down to the BS, the UE may request that the BS and the network store/retain the information and/or context of the UE. As a result, a procedure required when the UE reenters the network may be minimized and the UE may rapidly perform the network reentry. In the following description, the UE may be the M2M device.

FIG. 9 shows an example of a method for retaining context of a UE under an abnormal power down according to an embodiment of the present invention.

In step S100, when the abnormal power down occurs, the UE transmits the abnormal power down report and the request for retaining the context of the UE to the BS. The abnormal power down report may be the abnormal power down signaling header of Table 4 described above. The request for retaining the context of the UE may be included in the abnormal power down report.

In step S110, upon receiving the abnormal power down report of the UE and the context retention request of the UE, the BS determines whether to store/retain the context of the corresponding UE, which is required for the network reentry. When the BS determines to store/retain the context of the UE, the BS may allocate an identifier for identifying the corresponding UE. In this case, the identifier may be newly allocated or as the identifier, the existing allocated identifier may be used again. The existing allocated identifier may be a context retention identifier (CRID).

In step S120, the BS transmits the abnormal power down confirmation to the UE. Accordingly, the BS may notify whether to store/retain the context of the UE to the corresponding UE. The abnormal power down confirmation may be transmitted via a newly defined abnormal power down confirmation header or a newly defined MAC management message. Alternatively, the abnormal power down confirmation may be transmitted via any one of the existing MAC management messages. For example, the abnormal power down confirmation may be transmitted via the ranging response message (AAI-RNG-RSP). Alternatively, the abnormal power down confirmation may be transmitted via any one of the existing A-MAP IEs. For example, the abnormal power down confirmation may be transmitted via the BR-ACK A-MAP IE. Meanwhile, when the BS allocates a new identifier to the corresponding UE, the BS should notify the corresponding identifier to the UE.

Hereinafter, various examples of the abnormal power down confirmation are described.

Table 6 shows an example of the abnormal power down confirmation header transmitted as a form of a newly defined header.

TABLE 6

| | | |
|---|---|---|
| | Size | |
| Field | (bits) | Notes |

Abnormal Power Down
Confirmation( ){

| FID | 4 | Flow Identifier. Set to 0b0010 |
|---|---|---|
| Type | 5 | MAC Signaling header type = 0b01001 |
| Length | 3 | Indicates the length of the signaling header in |
| | | bytes |
| | | 0b000 and 0b001: Reserved |
| | | 0b010: 2 bytes |
| | | 0b011: 3 bytes |
| | | 0b100: 4 bytes |
| | | 0b101: 5 bytes |
| | | 0b110: 6 bytes |
| | | 0b111: xx bytes |
| Context Retention | 1 | Indicates whether the network retains context |
| indicator | | of the M2M device that sent the abnormal |

power down report or not.
0b0: No retention of the M2M device's
context
0b1: Retention of the M2M device's context

If (Context Retention

indicator == 0b1) {

| | | |
|---|---|---|
| ID } | x | Identifier for the M2M device that sent the |

| | | abnormal power down report |
|---|---|---|
| Reserved | x | Reserved. This field shall be set to Zero. |

}

Referring to Table 6, the abnormal power down confirmation header includes a Context Retention Indicator field. Accordingly, the BS may notify to the UE whether to retain the context of the UE which is abnormally powered down. Further, when the BS determines to retain the context of the UE, the abnormal power down confirmation header includes the ID of the UE to identify the UE.

Table 7 shows another example of the abnormal power down confirmation header transmitted as a form of a newly defined header.

TABLE 7

| | | |
|---|---|---|
| | Size | |
| Field | (bits) | Notes |

Abnormal Power Down
Confirmation( ){

| FID | 4 | Flow Identifier. Set to 0b0010 |
|---|---|---|
| Type | 5 | MAC Signaling header type = 0b01001 |
| Length | 3 | Indicates the length of the signaling header in |
| | | bytes |
| | | 0b000 and 0b001: Reserved |
| | | 0b010: 2 bytes |
| | | 0b011: 3 bytes |
| | | 0b100: 4 bytes |
| | | 0b101: 5 bytes |
| | | 0b110: 6 bytes |
| | | 0b111: xx bytes |
| Context Retention | 1 | Indicates whether the network retains context |
| indicator | | of the M2M device that sent the abnormal |
| | | power down report or not. |
| | | 0b0: No retention of the M2M device's |
| | | context |
| | | 0b1: Retention of the M2M device's context |
| Reserved | | Reserved. This field shall be set to Zero. |

}

Referring to Table 7, the abnormal power down confirmation header includes the Context Retention Indicator field. Accordingly, the BS may notify to the UE whether to retain the context of the UE which is abnormally powered down.

Table 8 shows another example of the abnormal power down confirmation header transmitted as a form of a newly defined header.

TABLE 8

| | | |
|---|---|---|
| | Size | |
| Field | (bits) | Notes |

Abnormal Power Down
Confirmation( ){

| FID | 4 | Flow Identifier. Set to 0b0010 |
|---|---|---|
| Type | 5 | MAC Signaling header type = 0b01001 |
| Length | 3 | Indicates the length of the signaling header in |
| | | bytes = 0b111 |
| | | 0b000 and 0b001: Reserved |
| | | 0b010: 2 bytes |
| | | 0b011: 3 bytes |
| | | 0b100: 4 bytes |
| | | 0b101: 5 bytes |
| | | 0b110: 6 bytes |
| | | 0b111: Extensions |
| Extended Length | 3 | 0b000: xx bytes |
| | | 0b00 and 0b111: Reserved |
| Context Retention | 1 | Indicates whether the network retains context |
| indicator | | of the M2M device that sent the abnormal |

power down report or not.
0b0: No retention of the M2M device's
context
0b1: Retention of the M2M device's context

If (Context Retention

indicator == 0b1) {

| | | | |
|---|---|---|---|
| ID | } | x | Identifier for the M2M device that sent the |
| | | | abnormal power down report |

| | | |
|---|---|---|
| Reserved | x | Reserved. This field shall be set to Zero. |

}

Referring to Table 8, the abnormal power down confirmation header includes the Context Retention Indicator field. Accordingly, the BS may notify to the UE whether to retain the context of the UE which is abnormally powered down. Further, when the BS determines to retain the context of the UE, the abnormal power down confirmation header includes the ID of the UE to identify the UE.

Table 9 shows another example of the abnormal power down confirmation header transmitted as a form of a newly defined header.

TABLE 9

| | | |
|---|---|---|
| | Size | |
| Field | (bits) | Notes |

Abnormal Power Down
Confirmation( ){

| FID | 4 | Flow Identifier. Set to 0b0010 |
|---|---|---|
| Type | 5 | MAC Signaling header type = 0b01001 |
| Length | 3 | Indicates the length of the signaling header in |
| | | bytes = 0b111 |
| | | 0b000 and 0b001: Reserved |
| | | 0b010: 2 bytes |
| | | 0b011: 3 bytes |
| | | 0b100: 4 bytes |
| | | 0b101: 5 bytes |
| | | 0b110: 6 bytes |
| | | 0b111: Extensions |
| Extended Length | 3 | 0b000: xx bytes |
| | | 0b000 and 0b111: Reserved |
| Context Retention | 1 | Indicates whether the network retains context |
| indicator | | of the M2M device that sent the abnormal |
| | | power down report or not. |
| | | 0b0: No retention of the M2M device's |
| | | context |
| | | 0b1: Retention of the M2M device's context |
| Reserved | x | Reserved. This field shall be set to Zero. |

}

Referring to Table 9, the abnormal power down confirmation header includes the Context Retention Indicator field. Accordingly, the BS may notify to the UE whether to retain the context of the UE which is abnormally powered down.

Table 10 shows another example of the abnormal power down confirmation header transmitted as a form of a newly defined header.

TABLE 10

| | | |
|---|---|---|
| | Size | |
| Field | (bits) | Notes |

Abnormal Power Down
Confirmation( ){

| FID | 4 | Flow Identifier. Set to 0b0010 |
|---|---|---|
| Type | 5 | MAC Signaling header type = 0b01001 |
| Length | 3 | Indicates the length of the signaling header in |
| | | bytes |
| | | 0b000 and 0b001: Reserved |
| | | 0b010: 2 bytes |
| | | 0b011: 3 bytes |
| | | 0b100: 4 bytes |
| | | 0b101: 5 bytes |
| | | 0b110: 6 bytes |
| | | 0b111: xx bytes |
| Context Retention | 5 | For each bit location, a value of 0 indicates the |

| | |
|---|---|
| Information element | information for the associated network reentry |
| | control messages shall not be retained and |
| | managed; a value of 1 indicates the |
| | information for the associated network reentry |
| | control message shall be retained and |
| | managed. |
| | Bit 0: Retain AMS service and operational |
| | information associated with |
| | AAISBCREQ/RSP messages. |
| | Bit 1: Retain AMS service and operational |
| | information associated with |
| | AAIPKMREQ/RSP messages. |
| | Bit 2: Retain AMS service and operational |
| | information associated with |
| | AAIREGREQ/RSP messages. |
| | Bit 3: Retain AMS service and operational |
| | information associated with network address. |
| | Bit 4: Retain AMS state information. The |
| | information retained by setting bit 4 includes |
| | configuration of all Service Flows in the AMS |
| | as set by successful AAI-DSA and AAI-DSC |
| | transactions. In particular it includes FIDs and |
| | related description (QoS descriptors and CS |
| | classifier information). |

If(Context Retention

Information element
!= 0b00000){

| | | | |
|---|---|---|---|
| ID | } | x | Identifier for the M2M device that sent the |
| | | | abnormal power down report |

| | | |
|---|---|---|
| Reserved | x | Reserved. This field shall be set to Zero. |

}

Referring to Table 10, the abnormal power down confirmation header includes the Context Retention Information element field. Accordingly, the BS may notify to the UE which context, among contexts of the UE which is abnormally powered down, is retained. When the BS determines to retain the context of the UE, the BS may set a value of a bit corresponding to the Context Retention Information element field to 1. Further, when the BS determines to retain at least one context of the UE, the abnormal power down confirmation header includes the ID of the UE to identify the UE.

Table 11 shows another example of the abnormal power down confirmation header transmitted as a form of a newly defined header.

TABLE 11

| | | |
|---|---|---|
| | Size | |
| Field | (bits) | Notes |

Abnormal Power Down
Confirmation( ){

| | FID | 4 | Flow Identifier. Set to 0b0010 |
|---|---|---|---|
| | Type | 5 | MAC Signaling header type = 0b01001 |
| | Length | 3 | Indicates the length of the signaling header in |
| | | | bytes |
| | STID | 12 | Indicates STID of the M2M device that transmits |
| | | | this M2M abnormal power down report signaling |
| | | | header. |
| | STID_Valid_Offset | 3 | Indicates STID_Valid_Offset of the M2M device |
| | | | that sends this M2M abnormal power down |
| | | | report signaling header. If the assigned STID is |
| | | | not shared with other M2M devices, M2M device |
| | | | shall set this field to zero. |
| | Emergency Type | 3 | 0b000: power outage |
| | | | 0b001~0b111: Reserved |
| | Context Retention | 5 | For each bit location, a value of 0 indicates the |
| Information element | | | information for the associated network reentry |
| | | | control messages shall not be retained and |
| | | | managed; a value of 1 indicates the information |
| | | | for the associated network reentry control |
| | | | message shall be retained and managed. |
| | | | Bit 0: Retain AMS service and operational |
| | | | information associated with AAI-SBC-REQ/RSP |
| | | | messages. |
| | | | Bit 1: Retain AMS service and operational |
| | | | information associated with AAI-PKM- |
| | | | REQ/RSP messages. |
| | | | Bit 2: Retain AMS service and operational |
| | | | information associated with AAI-REG-REQ/RSP |
| | | | messages. |
| | | | Bit 3: Retain AMS service and operational |
| | | | information associated with network address. |
| | | | Bit 4: Retain AMS state information. The |
| | | | information retained by setting bit 4 includes |
| | | | configuration of all Service Flows in the AMS as |
| | | | set by successful AAI-DSA and AAI-DSC |
| | | | transactions. In particular it includes FIDs and |
| | | | related description (QoS descriptors and CS |
| | | | classifier information). |
| | Reserved | 13 | Reserved. This field shall be set to Zero. |

}

Referring to Table 11, the abnormal power down confirmation header includes the Context Retention Information element field. Accordingly, the BS may notify to the UE which context, among contexts of the UE which is abnormally powered down, is retained. When the BS determines to retain the context of the UE, the BS may set the value of the bit corresponding to the context retention information element field to 1.

Table 12 shows another example of the abnormal power down confirmation header transmitted as a form of a newly defined header.

TABLE 12

| | | |
|---|---|---|
| | Size | |
| Field | (bits) | Notes |

Abnormal Power Down
Confirmation( ){

| | FID | 4 | Flow Identifier. Set to 0b0010 |
|---|---|---|---|
| | Type | 5 | MAC Signaling header type = 0b01001 |
| | Length | 3 | Indicates the length of the signaling header in |
| | | | bytes |
| | STID | 12 | Indicates STID of the M2M device in the |
| | | | received M2M Abnormal Power Down signaling |
| | | | header. |
| | STID_Valid_Offset | 3 | Indicates STID_Valid_Offset of the M2M device |
| | | | in the received M2M Abnormal Power Down |
| | | | signaling header. If the assigned STID is not |
| | | | shared with other M2M devices, M2M device |
| | | | shall set this field to zero. |
| | Context Retention | 5 | For each bit location, a value of 0 indicates the |
| Information element | | | information for the associated network reentry |
| | | | control messages shall not be retained and |
| | | | managed; a value of 1 indicates the information |
| | | | for the associated network reentry control |
| | | | message shall be retained and managed. |
| | | | Bit 0: Retain AMS service and operational |
| | | | information associated with AAI-SBC-REQ/RSP |
| | | | messages. |
| | | | Bit 1: Retain AMS service and operational |
| | | | information associated with AAI-PKM- |
| | | | REQ/RSP messages. |
| | | | Bit 2: Retain AMS service and operational |
| | | | information associated with AAI-REG-REQ/RSP |
| | | | messages. |
| | | | Bit 3: Retain AMS service and operational |
| | | | information associated with network address. |
| | | | Bit 4: Retain AMS state information. The |
| | | | information retained by setting bit 4 includes |
| | | | configuration of all Service Flows in the AMS as |
| | | | set by successful AAI-DSA and AAI-DSC |
| | | | transactions. In particular it includes FIDs and |
| | | | related description (QoS descriptors and CS |
| | | | classifier information). |
| | Reserved | 16 | Reserved. This field shall be set to Zero. |

}

Referring to Table 12, the abnormal power down confirmation header includes the Context Retention Information element field. Accordingly, the BS may notify to the UE which context, among contexts of the UE which is abnormally powered down, is retained. When the BS determines to retain the context of the UE, the BS may set the value of the bit corresponding to the context retention information element field to 1.

Table 13 shows an example of the abnormal power down confirmation transmitted as a form of an MAC management message.

TABLE 13

| | | Size | |
|---|---|---|---|
| Field | | (bits) | Notes |
| ... | | | |
| Context Retention | | 1 | Indicates whether the network retains |
| indicator | | | context of the M2M device that sent the |
| | | | abnormal power down report or not. |
| | | | 0b0: No retention of the M2M device's |
| | | | context |
| | | | 0b1: Retention of the M2M device's |
| | | | context |
| If (Context Retention | | | |
| indicator == 0b1) { | | | |
| | ID } | x | Identifier for the M2M device that sent the |

| | |
|---|---|
| | abnormal power down report |
| ... | |

Referring to Table 13, the MAC management message includes the Context Retention indicator field. Accordingly, the BS may notify to the UE whether to retain the context of the UE which is abnormally powered down. Further, the MAC management message including the abnormal power down confirmation includes the ID of the UE to identify the UE.

Table 14 shows another example of the abnormal power down confirmation transmitted as a form of an MAC management message.

TABLE 14

| | Size | |
|---|---|---|
| Field | (bits) | Notes |
| ... | | |
| Context Retention | 1 | Indicates whether the network retains |
| indicator | | context of the M2M device that sent the |
| | | abnormal power down report or not. |
| | | 0b0: No retention of the M2M device's |
| | | context |
| | | 0b1: Retention of the M2M device's |
| | | context |
| ... | | |

Referring to Table 14, the MAC management message includes the Context Retention indicator field. Accordingly, the BS may notify to the UE whether to retain the context of the UE which is abnormally powered down.

Table 15 shows another example of the abnormal power down confirmation transmitted as a form of an MAC management message.

TABLE 15

| | Size | |
|---|---|---|
| Field | (bits) | Notes |
| ... | | |
| Context Retention | 5 | For each bit location, a value of 0 indicates the information |
| Information element | | for the associated network reentry control messages shall not |
| | | be retained and managed; a value of 1 indicates the |
| | | information for the associated network reentry control |
| | | message shall be retained and managed. |
| | | Bit 0: Retain AMS service and operational information |
| | | associated with AAISBCREQ/RSP messages. |
| | | Bit 1: Retain AMS service and operational information |
| | | associated with AAIPKMREQ/RSP messages. |
| | | Bit 2: Retain AMS service and operational information |
| | | associated with AAIREGREQ/RSP messages. |
| | | Bit 3: Retain AMS service and operational information |
| | | associated with network address. |
| | | Bit 4: Retain AMS state information. The information retained |
| | | by setting bit 4 includes configuration of all Service Flows in |
| | | the AMS as set by successful AAI-DSA and AAI-DSC |
| | | transactions. In particular it includes FIDs and related |
| | | description (QoS descriptors and CS classifier information). |
| ... | | |

Referring to Table 15, the MAC management message includes the Context Retention Information element field. Accordingly, the BS may notify to the UE which context, among contexts of the UE which is abnormally powered down, is retained. When the BS determines to retain the context of the UE, the BS may set the value of the bit corresponding to the context retention information element field to 1.

Table 16 shows an example of the abnormal power down confirmation transmitted as a form of an A-MAP IE.

TABLE 16

| | | Size | |
|---|---|---|---|
| Field | | (bits) | Notes |
| ... | | | |
| Preamble sequence | | 5 | Preamble sequence index received in the BR opportunity |
| index | | | |
| MSG decoding | | 1 | To indicate the decoding status of quick access message |
| indicator | | | 0b0: MSG not decoded |
| | | | 0b1: MSG decoded relevant to Preamble sequence index |
| .... | | | |
| If (MSG decoding | | | |
| indicator == 0b1) { | | | |
| Context Retention | | 1 | Indicates whether the network retains context of the M2M |
| indicator | | | device that sent the abnormal power down report or not. If |
| | | | the BR index does not indicate abnormal power down, this |
| | | | field shall be set to 0b0. |
| | | | 0b0: No retention of the M2M device's context |
| | | | 0b1: Retention of the M2M device's context |
| If (Context Retention | | | |
| indicator == 0b1) { | | | |
| ID | } } | x | Identifier for the M2M device that sent the abnormal power |
| | | | down report |
| .... | | | |

Referring to Table 16, the A-MAP IE includes the Context Retention indicator field. Accordingly, the BS may notify to the UE whether to retain the context of the UE which is abnormally powered down. Further, the A-MAP IE including the abnormal power down confirmation includes the ID of the UE to identify the A-MAP IE.

Table 17 shows another example of the abnormal power down confirmation transmitted as a form of an A-MAP IE.

TABLE 17

| | Size | |
|---|---|---|
| Field | (bits) | Notes |
| ... | | |
| Preamble sequence | 5 | Preamble sequence index received in the BR opportunity |
| index | | |
| MSG decoding | 1 | To indicate the decoding status of quick access message 0b0: |
| indicator | | MSG not decoded |
| | | 0b1: MSG decoded relevant to Preamble sequence index |
| .... | | |
| If (MSG decoding | | |
| indicator == 0b1) { | | |
| Context Retention | 1 | Indicates whether the network retains context of the M2M |
| indicator } | | device that sent the abnormal power down report or not. If |
| | | the BR index does not indicate abnormal power down, this |
| | | field shall be set to 0b0. |
| | | 0b0: No retention of the M2M device's context |
| | | 0b1: Retention of the M2M device's context |
| .... | | |

Referring to Table 17, the A-MAP IE includes the Context Retention indicator field. Accordingly, the BS may notify to the UE whether to retain the context of the UE which is abnormally powered down.

Table 18 shows another example of the abnormal power down confirmation transmitted as a form of an A-MAP IE.

TABLE 18

| | Size | |
|---|---|---|
| Field | (bits) | Notes |
| ... | | |
| Preamble sequence | 5 | Preamble sequence index received in the BR opportunity |
| index | | |
| MSG decoding | 1 | To indicate the decoding status of quick access message 0b0: |
| indicator | | MSG not decoded |
| | | 0b1: MSG decoded relevant to Preamble sequence index |
| .... | | |
| If (MSG decoding | | |
| indicator == 0b1){ | | |
| Context Retention | 5 | For each bit location, a value of 0 indicates the information |
| Information | | for the associated network reentry control messages shall not |
| element } | | be retained and managed; a value of 1 indicates the |
| | | information for the associated network reentry control |
| | | message shall be retained and managed. |
| | | Bit 0: Retain AMS service and operational information |
| | | associated with AAISBCREQ/RSP messages. |
| | | Bit 1: Retain AMS service and operational information |
| | | associated with AAIPKMREQ/RSP messages. |
| | | Bit 2: Retain AMS service and operational information |
| | | associated with AAIREGREQ/RSP messages. |
| | | Bit 3: Retain AMS service and operational information |
| | | associated with network address. |
| | | Bit 4: Retain AMS state information. The information |
| | | retained by setting bit 4 includes configuration of all Service |
| | | Flows in the AMS as set by successful AAI-DSA and AAI- |
| | | DSC transactions. In particular it includes FIDs and related |
| | | description (QoS descriptors and CS classifier information). |
| .... | | |

Referring to Table 18, the A-MAP IE includes the Context Retention Information element field. Accordingly, the BS may notify to the UE which context, among contexts of the UE which is abnormally powered down, is retained. When the BS determines to retain the context of the UE, the BS may set the value of the bit corresponding to the context retention information element field to 1.

The abnormal power down confirmation header, the MAC management message, or the A-MAP IE including the abnormal power down confirmation described above through the tables is just the embodiment. The abnormal power down confirmation header, the MAC management message, or the A-MAP IE according to the embodiment of the present invention may include another field not displayed in the above tables and some of the fields displayed in the tables may be skipped.

When the BS stores/retains the context of the UE, the UE transmits the ID allocated to the UE to the BS during the network reentry. The ID of the UE may be transmitted through the AAI-RNG-REQ message, etc. When a new identifier is allocated to the UE which is abnormally powered down, a network reentry procedure of the UE is performed similarly to the network reentry procedure in the deregistration with context retention (DCR) mode, but not the CRID but the newly allocated ID needs to be transmitted. For example, when the newly allocated ID is transmitted through the AAI-RNG-REQ message, the ranging purpose indication field within the AAI-RNG-REQ message may be set to indicate the network reentry after abnormal power down. When the UE which is abnormally powered down uses the CRID, the network reentry procedure may be performed similarly to the existing network reentry procedure in the DCR mode. The BS may perform the remaining network reentry process by using the context of the UE identified by the corresponding ID. Further, the UE and the BS operate in the same manner as the DCR mode, however, a context retention timer may not operate. That is, the context of the corresponding UE may not be stored/retained only for a predetermined time.

When the BS does not store/retain the context of the UE, the UE which is abnormally powered down may perform the network entry again in the same manner as the initial network entry.

FIG. 10 is a block diagram showing wireless communication system to implement an embodiment of the present invention.

A BS 800 may include a processor 810, a memory 820 and a radio frequency (RF) unit 830. The processor 810 may be configured to implement proposed functions, procedures and/or methods described in this description. Layers of the radio interface protocol may be implemented in the processor 810. The memory 820 is operatively coupled with the processor 810 and stores a variety of information to operate the processor 810. The RF unit 830 is operatively coupled with the processor 810, and transmits and/or receives a radio signal.

An M2M device 900 may include a processor 910, a memory 920 and a RF unit 930. The processor 910 may be configured to implement proposed functions, procedures and/or methods described in this description. Layers of the radio interface protocol may be implemented in the processor 910. The memory 920 is operatively coupled with the processor 910 and stores a variety of information to operate the processor 910. The RF unit 930 is operatively coupled with the processor 910, and transmits and/or receives a radio signal.

The processors 810, 910 may include application-specific integrated circuit (ASIC), other chipset, logic circuit and/or data processing device. The memories 820, 920 may include read-only memory (ROM), random access memory (RAM), flash memory, memory card, storage medium and/or other storage device. The RF units 830, 930 may include baseband circuitry to process radio frequency signals. When the embodiments are implemented in software, the techniques described herein can be implemented with modules (e.g., procedures, functions, and so on) that perform the functions described herein. The modules can be stored in memories 820, 920 and executed by processors 810, 910. The memories 820, 920 can be implemented within the processors 810, 910 or external to the processors 810, 910 in which case those can be communicatively coupled to the processors 810, 910 via various means as is known in the art.

In view of the exemplary systems described herein, methodologies that may be implemented in accordance with the disclosed subject matter have been described with reference to several flow diagrams. While for purposed of simplicity, the methodologies are shown and described as a series of steps or blocks, it is to be understood and appreciated that the claimed subject matter is not limited by the order of the steps or blocks, as some steps may occur in different orders or concurrently with other steps from what is depicted and described herein. Moreover, one skilled in the art would understand that the steps illustrated in the flow diagram are not exclusive and other steps may be included or one or more of the steps in the example flow diagram may be deleted without affecting the scope and spirit of the present disclosure.

What is claimed is:

1. A method for retaining, by a base station, a context of a user equipment (UE) in a wireless communication system, the method comprising:
receiving an abnormal power down report and a request for retaining a context of a UE from the UE when an abnormal power down of the UE occurs;
determining whether to retain the context of the UE; and
transmitting an abnormal power down confirmation that indicates whether to retain the context of the UE to the UE.

2. The method of claim 1, wherein the abnormal power down confirmation is transmitted via an abnormal power down confirmation header.

3. The method of claim 1, wherein the abnormal power down confirmation is transmitted via a media access control (MAC) management message.

4. The method of claim 1, wherein the abnormal power down confirmation is transmitted via an A-MAP information element (IE).

5. The method of claim 1, further comprising:
transmitting an identifier of the UE to the UE when it is determined to retain the context of the UE.

6. The method of claim 5, wherein the identifier of the UE is one of an identifier newly allocated to the UE which is abnormally powered down or a context retention identifier (CRID).

7. The method of claim 1, wherein the abnormal power down confirmation is configured by 1 bit.

8. The method of claim 1, wherein the abnormal power down confirmation indicates whether to retain information on a corresponding network reentry control message among the context of the UE.

9. The method of claim 1, further comprising:
performing network reentry with the UE based on the retained context of the UE.

10. A method for performing, by user equipment (UE), network reentry in a wireless communication system, the method comprising:
transmitting an abnormal power down report and a request for retaining a context of a UE to a base station (BS) when an abnormal power down of the UE occurs;
receiving an abnormal power down confirmation, which indicates whether the context of the UE is retained, and an identifier of the UE from the BS; and
performing network reentry with the BS by transmitting the identifier of the UE to the BS.

11. The method of claim 10, wherein the abnormal power down confirmation and the identifier of the UE are transmitted via an abnormal power down confirmation header.

12. The method of claim 10, wherein the abnormal power down confirmation and the identifier of the UE are transmitted via a media access control (MAC) management message.

13. The method of claim 10, wherein the abnormal power down confirmation and the identifier of the UE are transmitted via an A-MAP information element (IE).

14. The method of claim 10, wherein the identifier of the UE is one of an identifier newly allocated to the UE which is abnormally powered down or a context retention identifier (CRID).

15. A user equipment (UE) performing network reentry in a wireless communication system, the UE comprising:
a radio frequency (RF) unit for transmitting or receiving a radio signal; and
a processor coupled to the RF unit, and configured to:
transmit an abnormal power down report and a request for retaining a context of a UE to a base station (BS) when an abnormal power down of the UE occurs;
receive an abnormal power down confirmation, which indicates whether the context of the UE is retained, and an identifier of the UE from the BS; and
perform network reentry with the BS by transmitting the identifier of the UE to the BS.
